(19) United States
(12) Patent Application Publication
(10) Pub. No.: US 2026/0208775 A1
(43) Pub. Date: Jul. 23, 2026

(54) COMPUTER-IMPLEMENTED METHOD AND SYSTEM FOR AUTOMATICALLY FORMULATING ELECTRIC MULTIPLE UNIT CIRCULATION PLAN

(71) Applicant: BEIJING JIAOTONG UNIVERSITY, Beijing (CN)

(72) Inventors: Ying WANG, Beijing (CN); Jiarui ZHANG, Beijing (CN); Hanxiao ZHOU, Hangzhou (CN); Jianhua LU, Beijing (CN); Jianrui MIAO, Beijing (CN); Zhengwen LIAO, Beijing (CN)

(21) Appl. No.: 19/572,086

(22) Filed: Mar. 19, 2026

(30) Foreign Application Priority Data
Dec. 31, 2025 (CN) 202512044974.0

(51) Int. Cl. B61L 27/16; B61L 25/02; B61L 27/57

(52) U.S. Cl. CPC B61L 27/16; B61L 25/025; B61L 27/57

(57) ABSTRACT

A method for formulating an electric multiple unit (EMU) circulation plan is provided, in which the state data of the EMUs is collected by an onboard sensor assembly deployed on the EMUs in real time, including actual position information, accumulated mileage data, and maintenance state data; a spatiotemporal network is established based on the state data; an original model is established based on the state data and the spatiotemporal network; an aggregative optimization model is established based on the state data and the original model; an aggregation result is obtained by the aggregative optimization model based on the state data; a disaggregation model is established based on the aggregation result; and a an EMU circulation plan is automatically generated by the disaggregation model by combining the aggregation result with the state data in real time.

### CROSS-REFERENCE TO RELATED APPLICATIONS

This application claims the benefit of priority from Chinese Patent Application No. 202512044974.0, filed on Dec. 31, 2025. The content of the aforementioned application, including any intervening amendments thereto, is incorporated herein by reference in its entirety.

### TECHNICAL FIELD

This application relates to the technical field of computer-implemented optimization, and more particularly to a computer-implemented method and system for automatically formulating an electric multiple unit (EMU) circulation plan.

### BACKGROUND

The formulation of EMU circulation plans plays a critical role in the high-speed railway operation, and its solving efficiency will directly determine the timeliness and practicability of the formulated circulation plans, thereby affecting the response speed and quality of the operating adjustments. With the continuous expansion of the high-speed railway network and the increasing frequency of the train operation, there is an explosive increase in the search space of the circulation plan problem, posing severe challenges to traditional methods in the solving speed. Moreover, the existing methods are generally unable to acquire real-time position information and accumulated mileage data of EMUs, such that the formulated circulation plans lack pertinence and practicability, and fail to achieve EMU-identified routing arrangements based on the actual EMU operating states. Currently, the existing methods for formulating EMU circulation plans mainly rely on personal experience. Conventional manual formulation methods suffer from heavy labor intensity and low efficiency, and are no longer suitable for the high-precision and high-efficiency formulation requirements of the large-scale railway networks. More importantly, since the existing methods are unable to obtain the real-time position information and the accumulated mileage data of the EMUs, the formulated circulation plans fail to take the actual operating states of the EMUs into consideration, which easily leads to issues such as mismatched EMU position and exceeded mileage limit.

Most of the existing methods focus on establishing precise mathematical models, such as integer programming models, multi-commodity network flow models, or dynamic programming models, to pursue theoretically optimal solutions, and rely on commercial solvers or decomposition algorithms for computation. Although these methods exhibit favorable theoretical properties under linear scenarios, they will suffer from sharply-increasing time consumption as the railway network scale grows, and even fails to output feasible solutions within an acceptable duration. This significantly limits their applicability in practical scenarios involving complex railway networks and high-density operation. So far, some attempts have been made to introduce heuristic rules or metaheuristic algorithms to improve the solving efficiency, but these methods still face challenges when dealing with ultra-large-scale problems or complex and unexpected scenarios, including slow convergence, unstable solution quality, and tendency to be trapped in local optima. In addition, the existing methods generally lack efficient search strategies and pruning mechanisms tailored to the structural characteristics of the high-speed railway routing, making it difficult to achieve a balance between the solution speed and the solution quality.

The above-mentioned existing methods for formulating EMU circulation plans suffer from the following drawbacks.

Currently, the manual formulation methods suffer from problems such as tight time constraints, heavy workload, low efficiency, and insufficient accuracy. In addition, these methods are also dependent on factors such as the individual experience and professional competence of the planners, and thus are difficult to meet the development requirements of railway operations.

### SUMMARY

To address the above technical issues in the prior art, the present disclosure provides a method for rapidly formulating an EMU circulation plan.

To achieve the above objective, the present disclosure provides the following technical solutions.

In a first aspect of the present disclosure, a computer-implemented method for automatically formulating an electric multiple unit (EMU) circulation plan is provided. The computer-implemented method includes the following operations:
deploying an onboard sensor assembly on the EMUs;
acquiring, by the onboard sensor assembly, state data of the EMUs in real time;
establishing a spatiotemporal network based on the state data;
establishing an original model of the EMU circulation plan based on the state data and the spatiotemporal network, wherein the state data comprise operation state data and maintenance state data;
establishing an aggregative optimization model based on the state data and the original model;
solving the aggregative optimization model based on the state data to obtain an aggregation result;
establishing a disaggregation model based on the aggregation result; and
combining, by the disaggregation model, the aggregation result with the state data to automatically generate the EMU circulation plan in real time.

In some embodiments of the disclosure, the operation state data comprises an actual position information and accumulated mileage data; the actual position information comprises a current station, an operating section, or an EMU depot; and the accumulated mileage data comprises a total accumulated mileage, a daily accumulated mileage, and a maintenance cycle accumulated mileage.

In some embodiments of the disclosure, the step of establishing the spatiotemporal network based on the state data comprises:
based on the actual position information, establishing an initial node in the spatiotemporal network for each of the EMUs, and assigning a temporal attribute, a spatial attribute, and a state attribute to the initial node;
searching a database to determine the EMU depot, the current station, or the operating section of each of the EMUs, and establishing a virtual origin node and a virtual destination node for each of the EMUs;
comparing, via a maintenance state determination algorithm, the accumulated mileage data with a maintenance mileage threshold to determine a maintenance state of each of the EMUs;
for an EMU among the EMUs whose accumulated mileage data reaches the maintenance mileage threshold, restricting executable long-distance operating tasks of the EMU, and adjusting an arc capacity of the EMU;
for an EMU among the EMUs whose accumulated mileage data exceeds the maintenance mileage threshold, removing the EMU from an available EMU set such that no node in the spatiotemporal network is established for the EMU;
setting an operating section and a time window for each of the EMUs according to a preset maintenance plan; and
based on the state data, abstracting, via a network generation algorithm, stations in a train operation diagram as nodes, and feasible connection relationships between the stations as arcs, so as to establish the spatiotemporal network for a preset period based on the state data.

In some embodiments of the disclosure, the step of establishing the original model based on the state data and the spatiotemporal network comprises:
taking a candidate train set, a node set and an arc set as model parameters;
based on the actual position information, setting an initial position constraint for each of the EMUs to ensure that each of the EMUs starts executing the EMU circulation plan from its actual position;
based on the accumulated mileage data, setting a maintenance constraint to ensure that the maintenance cycle accumulated mileage of each of the EMUs does not exceed a maintenance mileage threshold prior to maintenance; and based on actual train operation diagram data, setting an operation diagram constraint, a station capacity constraint, and a flow balance constraint.

In some embodiments of the disclosure, the step of establishing the aggregative optimization model based on the state data and the original model comprises:
aggregating the actual position information and the accumulated mileage data in the state data of each of the EMUs into network-wide resource allocation information;
aggregating, via a data aggregation algorithm, train-level variables in the original model into arc-level flow variables to reduce model complexity;
determining a distribution state of the EMUs in the spatiotemporal network based on the actual position information of each of the EMUs, and determining a network-wide maintenance resource constraint based on the accumulated mileage data of each of the EMUs; and transforming the original model into the aggregative optimization model.

In some embodiments of the disclosure, an objective function of the aggregative optimization model is determined based on actual operating costs, wherein the actual operating costs comprise train utilization costs, operating costs, and maintenance costs.

In some embodiments of the disclosure, constraint conditions of the aggregative optimization model are determined based on actual train operation diagram data and the state data; and the constraint conditions of the aggregative optimization model comprise an operation diagram constraint, a station capacity constraint, and a flow balance constraint.

In some embodiments of the disclosure, the step of combining, by the disaggregation model, the aggregation result with the state data to automatically generate the EMU circulation plan in real time comprises:
based on the aggregation result and the state data, matching, via a data matching algorithm, the aggregation result with each of the EMUs to determine an operating section for each of the EMUs;
based on the aggregation result and the state data, generating an operating path for each of the EMUs;
determining, via a path optimization algorithm, an optimal starting position based on the actual position information, and ensuring that the accumulated mileage data of each of the EMUs does not exceed a maintenance mileage threshold; and generating the EMU circulation plan in real time, wherein the EMU circulation plan comprises an EMU identifier, an operating time, and an operating path.

In a second aspect of the present disclosure, a computer system is provided. The computer system comprises:
one or more processors;
a memory; and
one or more programs stored in the memory and configured to be executed by the one or more processors to cause the one or more processors to execute the computer-implemented method provided in any one of the above embodiments.

In a third aspect of the present disclosure, a non-transitory computer-readable storage medium is provided. The non-transitory computer-readable storage medium stores one or more programs which, when executed by one or more processors, cause the one or more processors to perform the computer-implemented method provided in any one of the above embodiments.

The technical solutions provided by the present disclosure achieve the following beneficial effects.

The present disclosure adopts a two-stage method that combines the aggregative optimization model with the disaggregation model, thereby decomposing a complex EMU circulation plan problem into two hierarchical levels for solution. In the aggregation stage, arc flows across the entire spatiotemporal network are rapidly determined. In the disaggregation stage, a detailed and executable EMU circulation plan is generated based on the aggregation result. The two-stage method effectively avoids the excessive solution time caused by combinatorial explosion in conventional methods, significantly improves computational efficiency, and is adapted to large-scale, high-density railway operation diagrams.

On the premise of ensuring the scientific validity and rationality of the EMU circulation plan, the present disclosure first allocates global resources using the aggregative optimization model, and then carries out elaborated path adjustments using the disaggregation model. This approach not only avoids the tendency of heuristic algorithms to become trapped in local optima, but also overcomes the limitations of precise models in rapidly solving large-scale problems, thereby achieving an effective balance between solution efficiency and solution quality.

During the establishment of the spatiotemporal network of the present disclosure, the actual position information and the accumulated mileage data of each EMU are fully taken into consideration, thereby enabling the formulation of EMU-identified circulation plans based on the actual operating states of the EMUs. This effectively prevents issues such as EMU position mismatches and mileage overrun, and improves the practicality and operability of the circulation plans.

The method provided by the present disclosure has high computational efficiency and strong adaptability, and can provide timely and reliable support for EMU utilization management, routine scheduling adjustments, and resource allocation. Accordingly, the method helps enhance the flexibility of high-speed railway operating organization and improves responsiveness to unexpected situations, and therefore has broad engineering application value.

The foregoing aspects or other aspects of the present disclosure will become more readily apparent from the following description of the embodiments. It should be understood that the above general description and the following detailed description are exemplary and explanatory only, and are not intended to limit the present disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

To describe technical solutions in embodiments of the present disclosure or the prior art more clearly, the following briefly introduces the accompanying drawings required for describing the embodiments or the prior art. Apparently, the accompanying drawings in the following description only illustrate some embodiments of the present disclosure. Those of ordinary skill in the art may also obtain other drawings based on these accompanying drawings without creative efforts.

FIG. 1 is a flow chart of a method for rapidly formulating an EMU circulation plan according to an embodiment of the present disclosure.

FIG. 2 is a schematic diagram illustrating a spatiotemporal network for performing uncoupling/recoupling operations in the method for rapidly formulating the EMU circulation plan according to an embodiment of the present disclosure.

FIG. 3 is a structural diagram of an optimization system for rapidly formulating an EMU circulation plan according to an embodiment of the present disclosure.

FIG. 4 illustrates a train operation diagram according to an embodiment of the present disclosure.

### DETAILED DESCRIPTION OF EMBODIMENTS

The technical solutions in embodiments of the present disclosure will be described clearly and completely below in conjunction with the accompanying drawings in the embodiments of the present disclosure. It is obvious that the described embodiments are merely some embodiments of the present disclosure, instead of all embodiments. Based on the embodiments in the present disclosure, all other embodiments obtained by those of ordinary skill in the art without making creative effort shall fall within the scope of the present disclosure.

The flow charts shown in the accompanying drawings are provided for illustrative purposes only, and are not required to include all contents or all operations/steps, nor are they required to be performed in the order described. For example, some operations/steps may be decomposed, combined, or partially merged, and thus the actual execution order may be changed according to specific circumstances.

It should be understood that the terminology used in the specification of the present disclosure is for the purpose of describing particular embodiments only and is not intended to limit the protection range of the present disclosure. As used in the specification of the present disclosure and the appended claims, unless the context clearly indicates otherwise, the singular forms “a,” “an,” and “the” are intended to include the plural forms as well.

Specifically, the embodiments of the present disclosure are further described below with reference to the accompanying drawings.

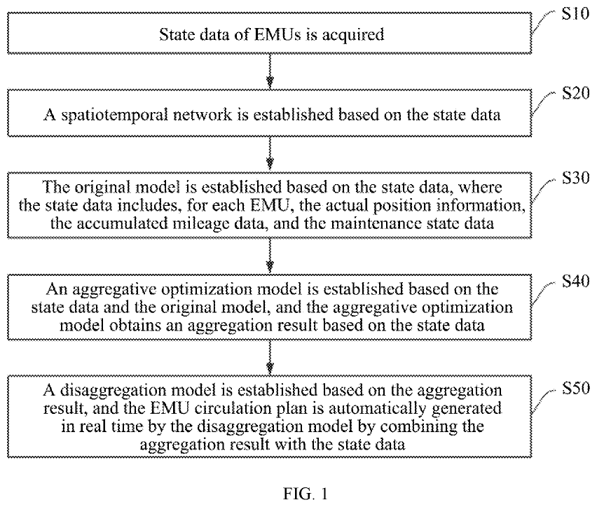

Referring to FIG. 1, FIG. 1 is a flow chart of a method for rapidly formulating an electric multiple unit (EMU) circulation plan according to an embodiment of the present disclosure. As shown in FIG. 1, the method for rapidly formulating the EMU circulation plan includes steps (S10) to (S50).

(S10) State data of EMUs is acquired.

In an embodiment of the present disclosure, the state data is collected by an onboard sensor assembly deployed on the EMUs and at least includes, for each of the EMUs, actual position information, accumulated mileage data, and maintenance state data.

In an embodiment of the present disclosure, the actual position information includes a current station, an operating section, or an EMU depot. An initial position constraint for each EMU at the start time of the circulation plan formulation is determined based on the actual position information.

In an embodiment of the present disclosure, the accumulated mileage data includes a total accumulated mileage, a daily accumulated mileage, and a maintenance cycle accumulated mileage. A maintenance state of each EMU and a maintenance constraint of each EMU are determined based on the accumulated mileage data.

In an embodiment of the present disclosure, the onboard sensor assembly at least includes a GPS positioning sensor and a mileage sensor. In an embodiment of the present disclosure, the actual position information of each EMU can be acquired through the GPS positioning sensor deployed on the EMU.

In an embodiment of the present disclosure, the accumulated mileage data of each EMU can be acquired through the mileage sensor deployed on the EMU.

In an embodiment of the present disclosure, the GPS positioning sensor includes a GPS data receiving module, a data processing module, and a data transmission module. The GPS data receiving module is configured to receive satellite signals and calculate precise position information of each EMU. The precise position information of each EMU includes latitude and longitude coordinates, altitude information, and motion states. The data processing module is configured to process and store data received by the GPS data receiving module. The data transmission module is configured to transmit the precise position information to a ground data processing center in real time.

The present disclosure is directed to a technical problem arising in computer-implemented railway operation and dispatching systems.

Specifically, in large-scale high-speed railway networks, a computing system is required to process massive volumes of state data acquired from the onboard sensor assembly, including the actual position information and the accumulated mileage data, and to generate executable EMU circulation plans within strict time constraints.

Conventional EMU circulation plans rely on train-level mathematical models that scale poorly with network size. As the number of EMUs, stations, and operating lines increases, the number of decision variables and constraints grows exponentially, leading to excessive computational latency, memory consumption, and solver instability. As a result, conventional EMU circulation plans are unable to satisfy real-time operational requirements and cannot be effectively deployed in practical railway dispatching systems.

Accordingly, there is a need for a computer-implemented technical solution that is capable of reducing computational complexity, improving solution efficiency, and reliably generating executable circulation plans under real-time physical constraints.

A technical problem addressed by the present disclosure is how to generate an executable EMU circulation plan in the computer system with acceptable computational complexity when processing large-scale real-time data obtained from the onboard sensor assembly.

In an embodiment of the present disclosure, the mileage sensor includes a mileage data acquiring module, a data storage module, and a communication module. The mileage data acquiring module is configured to record the accumulated mileage, the operating time, and the historical maintenance data of the EMU. The data storage module is configured to store the accumulated mileage data. The communication module is configured to transmit the mileage data to the ground data processing center in real time.

The mileage data acquiring module includes a rotation speed detection unit and a mileage calculation unit. The rotation speed detection unit is configured to detect wheel rotation with an accuracy of up to 0.1 kilometers. The mileage calculation unit is configured to calculate the accumulated mileage based on the wheel rotation speed and the wheel circumference.

The present disclosure is adapted to the computer system. The computer system may include an onboard data acquiring module, a data preprocessing module, a wireless communication module, a data compression module, and a ground data processing center. The onboard data acquiring module is configured to acquire and preprocess the state data. The wireless communication module adopts global system for mobile communications-railway (GSM-R) or fourth generation (4G)/fifth generation (5G) communication technology to enable real-time transmission of the state data. The ground data processing center is configured to receive, store, and process state data of all EMUs. In some embodiments, the ground data processing center may include at least one processor.

The onboard data acquiring module integrates data interfaces of the GPS positioning sensor and the mileage sensor. The data preprocessing module is configured to perform filtering processing on GPS data and anomaly detection on the mileage data. The wireless communication module adopts mobile communication technology and is equipped with antennas to ensure communication stability under high-speed operation and tunnel environments. The data compression module is configured to compress data for transmission. The ground data processing center includes a database server, an application server, and a storage system, adopts a distributed architecture, and supports real-time data processing and storage.

(S20) A spatiotemporal network is established based on the state data.

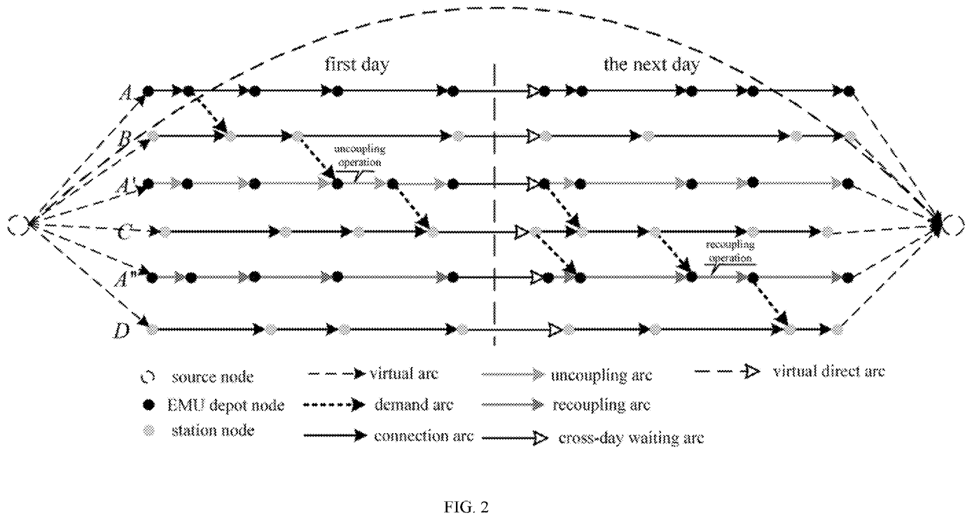

As shown in FIG. 2, in an embodiment of the present disclosure, at step (S20), the spatiotemporal network is established based on the state data as follows. A network establishing module of the ground data processing center is configured to establish the spatiotemporal network based on a train operation diagram, EMU information, station and EMU depot information, and the acquired state data of the EMUs, and the spatiotemporal network is denoted as G=(V,A).

In an embodiment of the present disclosure, the network establishing module of the ground data processing center is configured to establish the spatiotemporal network based on the train operation diagram, the EMU information, the station and EMU depot information, and the acquired state data of the EMUs as follows. Based on the actual position information of each EMU, an initial node is established in the spatiotemporal network for each EMU, and a temporal attribute, a spatial attribute, and a state attribute are assigned to the initial node. The EMU depot, the current station, or the operating section of each EMU are determined by searching a database, and a virtual origin node and a virtual destination node are established for each EMU.

The ground data processing center is configured to receive the actual position information from the GPS positioning sensor, and to match GPS coordinates with a railway network topology via a position-matching algorithm, thereby determining a precise position of each EMU at a start time of circulation plan formulation.

In an embodiment of the present disclosure, the operations that: based on the actual position information of each EMU, the initial node is established in the spatiotemporal network for each EMU, and the temporal attribute, the spatial attribute, and the state attribute are assigned to the initial node; and the EMU depot, the current station, or the operating section of each EMU are determined by searching the database, and the virtual origin node and the virtual destination node are established for each EMU, are performed as follows.

In the spatiotemporal network G, for ∀i∈V, there are three attributes tᵢ, sᵢ, φᵢ, which respectively represent time, location, and type. According to the type attribute, the nodes are classified into source nodes and station nodes, which are described in detail below.

Source nodes represent the virtual origin node and the virtual destination node of the spatiotemporal network. The virtual origin node and the virtual destination node are denoted as

$${V}_{vir}^{o} and {V}_{vir}^{d} ,$$

respectively, where for

$$i = {V}_{vir}^{o} ,$$

tᵢ=0; and for

$$i = {V}_{vir}^{d} ,$$

tᵢ=2880.

For all train services within a given range, one station node is established for representing the origin station of each train service, and another station node is established for representing the destination station of each train service. The station nodes for representing the origin stations of all train services constitute a set denoted as

$${V}_{n}^{o} ,$$

and the station nodes for representing the destination stations of all train services constitute a set denoted as

$${V}_{n}^{d} .$$

Due to practical operational requirements, EMUs depart only from certain designated stations and return to the same stations after completing corresponding operating tasks. Such designated stations are referred to as EMU depots. To distinguish EMU depot nodes from other station nodes, a set of EMU depot nodes is denoted as V_{base}. To ensure that each EMU departs from one EMU depot and returns to the same EMU depot, station nodes originally defined for one day are extended to two days. Station nodes of the next day are duplicated from those of the first day, with corresponding time attributes increased by 1440 minutes, while all other attributes remain identical to those of the first-day nodes. For

$$∀ i ∈ {V}_{n}^{o} ⋃ {V}_{n}^{d} ,$$

there are attributes eᵢ, nᵢ, and tᵢ, which respectively represent a train service identifier, an associated station, and an associated time.

To distinguish station nodes of the two days, sets of origin stations and destination stations of train services on the first day are denoted as

$${V}_{n 1}^{o} and {V}_{n 1}^{d} ,$$

respectively, and sets of origin stations and destination stations of train services on the next day are denoted as

$${V}_{n 2}^{o} and {V}_{n 2}^{d} ,$$

respectively.

Finally, all nodes constitute a set denoted as V.

The accumulated mileage data is compared with a maintenance mileage threshold via a maintenance state determination algorithm to determine a maintenance state of each EMU. For an EMU whose accumulated mileage data reaching the maintenance mileage threshold, executable long-distance operating tasks of the EMU are restricted, and an arc capacity of the EMU is adjusted accordingly. For an EMU whose accumulated mileage data exceeding the maintenance mileage threshold, the EMU is removed from an available EMU set such that no node in the spatiotemporal network is established for the EMU. An operating section and a time window are set for each EMU according to a preset maintenance plan.

In an embodiment of the present disclosure, the operations that: the accumulated mileage data is compared with the maintenance mileage threshold via the maintenance state determination algorithm to determine the maintenance state of each of the EMUs; for the EMU whose accumulated mileage data reaching the maintenance mileage threshold, executable long-distance operating tasks of the EMU are restricted, and an arc capacity of the EMU is adjusted; for the EMU whose accumulated mileage data exceeding the maintenance mileage threshold, the EMU is removed from the available EMU set such that no node in the spatiotemporal network is established for representing the EMU; and the operating section and the time window are set for each of the EMUs according to the preset maintenance plan, are performed as follows.

Arcs are established in the spatiotemporal network based on connectivity relationships among the nodes. In the spatiotemporal network G, for ∀(i, j)∈A, there are six attributes:

$${t}_{ij}^{o} , {t}_{ij}^{d} , {s}_{ij}^{o} , {s}_{ij}^{d} ,$$

φᵢⱼ, fᵢⱼ, and gᵢⱼ, representing arc start time, arc end time, arc origin station, arc destination station, arc type, marshalling type, and arc capacity, respectively. According to the arc type attribute, the arcs are classified into virtual arcs, demand arcs, connection arcs, uncoupling arcs, recoupling arcs, cross-day waiting arcs, and virtual direct arcs. For ∀(i, j)∈A, the following conditions are satisfied:

$${t}_{ij}^{o} = {t}_{i} , {t}_{ij}^{d} = {t}_{j} , {s}_{ij}^{o} = {s}_{i} , {s}_{ij}^{d} = {s}_{j} .$$

The virtual arc is used to connect the source node and EMU depot node, and includes a virtual origin arc and a virtual destination arc. For

$$∀ i ∈ {V}_{vir}^{o} ,$$

virtual origin arc (i, j) is established. All virtual origin arcs constitute a set denoted as Aᵥ. Similarly, for ∀i∈V_{base}

$$j ∈ {V}_{v i r}^{d} ,$$

a virtual destination arc (j) is established. All virtual destination arcs constitute a set denoted as A_{w}.

The demand arc is used to connect the station node representing the origin station of the train service and the station node representing the destination station of the train service. For

$$∀ i ∈ {V}_{n}^{o} , j ∈ {V}_{n}^{d} ,$$

if eᵢ=eⱼ, then a demand arc (i, j) is established. If fᵢⱼ=“single-unit”, then gᵢⱼ=1; if fᵢⱼ=“multiple-unit”, then gᵢⱼ=2. All demand arcs constitute a set denoted as A_{d}.

The connection arc is used to connect nodes of the train service. For

$$∀ i ∈ {V}_{n}^{o} ⋃ {V}_{n}^{d} , ∀ j ∈ {V}_{n}^{o} ⋃ {V}_{n}^{d} ,$$

if i≠j, nᵢ=nⱼ, and for

$$∀ k ∈ {V}_{n}^{o} ⋃ {V}_{n}^{d} ,$$

nₖ=nᵢ=nⱼ, tₖ≤tᵢ≤tⱼ or tᵢ≤tⱼ≤tₖ, then a connection arc (i, j) is established. For the connection arc (i, j), the arc start time is denoted as tᵢ, the arc end time is denoted as tⱼ, and the origin station of the connection arc (i, j) is denoted as

$${s}_{ij}^{o} ,$$

and the destination station of the connection arc (i, j) is denoted as

$${s}_{i j}^{d} , where {s}_{ij}^{o} = {s}_{ij}^{d} .$$

gᵢⱼ represents the maximum number of train sets that can be accommodated at the station. All connection arcs constitute a set denoted as A_{c}.

The uncoupling arcs are used for EMU uncoupling operations. Since the EMU uncoupling operations are typically performed only at the EMU depots, the uncoupling arcs are generated only between the EMU depot nodes in order to reduce network scale. For ∀i∈V_{base}, ∀j∈V_{base}, if i≠j, nᵢ=nⱼ, and for ∀k∈V_{base}, nₖ=nᵢ=nⱼ, tₖ≤tᵢ≤tⱼ or tᵢ≤tⱼ≤tₖ, then an uncoupling arc (i, j) is established. For the uncoupling arc (i, j), the arc start time is denoted as tᵢ, the arc end time is denoted as tⱼ, the arc origin station is denoted as

$${s}_{ij}^{o} ,$$

the arc destination station is denoted as

$${s}_{ij}^{d} , where {s}_{ij}^{o} = {s}_{ij}^{d} ,$$

the arc type satisfies φᵢⱼ=“uncoupling arc”, and gᵢⱼ represents the maximum number of train sets that can be accommodated at the station. All uncoupling arcs constitute a set denoted as Aₛ.

The recoupling arcs are used for EMU recoupling operations. The establishing rules of the recoupling arcs are the same as those of the uncoupling arcs, except that φᵢⱼ=“coupling arc”. All recoupling arcs constitute a set denoted as Aᵣ.

The cross-day waiting arc is used to connect the last time point of a station on the first day and the first time point of the same station on the next day. For

$$∀ i ∈ {V}_{n 1}^{o} ⋃ {V}_{n 1}^{d} , ∀ j ∈ {V}_{n 2}^{o} ⋃ {V}_{n 2}^{d} ,$$

if nᵢ=nⱼ and for

$$∀ k ∈ {V}_{n 1}^{o} ⋃ {V}_{n 1}^{d} , {k}^{′} ∈ {V}_{n 2}^{o} ⋃ {V}_{n 2}^{d} ,$$

nₖ=nᵢ=nⱼ=n_{k′}, tₖ≤tⱼ or tⱼ≤t_{k′}, then the cross-day waiting arc (i, j) is established. For the cross-day waiting arc, the arc start time is denoted as tᵢ, the arc end time is tⱼ, the arc origin station is denoted as

$${s}_{ij}^{o} ,$$

the arc destination station is denoted as

$${s}_{ij}^{d} , where {s}_{ij}^{o} = {s}_{ij}^{d} ,$$

and gᵢⱼ represents the maximum number of train sets that can be accommodated at the station. All cross-day waiting arcs constitute a set denoted as Aₒ.

The virtual direct arc is used to directly connect the virtual origin node and the virtual destination node, and represents an unused train set. All virtual direct arcs constitute a set denoted as A_{vw}.

Finally, all arcs constitute a set denoted as A.

Based on the state data, stations in the train operation diagram are abstracted as nodes and via the network generation algorithm of the ground data processing center and feasible connection relationships between stations are abstracted as arcs via a network generation algorithm of the ground data processing center, so as to establish the spatiotemporal network for a preset period based on the state data, and the spatiotemporal network is denoted as G(V,A). Each node in the spatiotemporal network has temporal information and spatial information obtained from the GPS positioning sensor, and each arc in the spatiotemporal network incorporates the maintenance constraint obtained from the mileage sensor.

The preset period may be two days, three days, or four days.

The state data includes, but is not limited to, departure stations, arrival stations, departure times, arrival times, operating times, accumulated mileage data, and marshalling states of the EMUs.

(S30) The original model is established based on the state data, where the state data includes, for each EMU, the actual position information, the accumulated mileage data, and the maintenance state data.

In an embodiment of the present disclosure, at step (S30), the original model is established based on the state data as follows. A model establishing module of the ground data processing center establishes the original model based on the spatiotemporal network, and the original model is configured to generate an executable circulation plan by using GPS positioning data and the accumulated mileage data as input parameters.

The original model is established based on the state data as follows. The state data of the EMUs, read from the database via the ground data processing center, include the GPS positioning data, the accumulated mileage data, and the maintenance state of each EMU. The real-time physical data is used as model parameters, including the candidate train set K (determined based on actually available EMUs), the node set N (determined based on the actual position obtained from the GPS positioning sensor), and the arc set A (determined based on an actual train operation diagram and time constraints).

Based on the actual position information, an initial position constraint is set for each EMU to ensure that each EMU starts executing the EMU circulation plan from the actual position of each EMU. Based on the accumulated mileage data, the maintenance constraint is set to ensure that the accumulated mileage data of each EMU does not exceed the maintenance mileage threshold prior to maintenance. Based on actual train operation diagram data, an operation diagram constraint, a station capacity constraint, and a flow balance constraint are set.

In an embodiment of the present disclosure, the maintenance mileage threshold is 8000 KM.

The actual train operation diagram data may be obtained from the train operation diagram at the dispatching and command center. The actual train operation diagram data may include datasets of train services, stations, arrival and departure times, and marshalling requirements, and the like, which are used for network establishing and constraint establishing.

The original model is established as follows.

### (1) Definition of Parameters and Variables

| Parameter Name | Definition |
|---|---|
| Sets: | |
| K | candidate train set |
| Q | train service set |
| N | node set, including train service nodes |
| | and EMU depot origin/destination nodes |
| A | arc set |
| A_{d} | demand arc set |
| Aᵥ | virtual origin arc set |
| A_{w} | virtual destination arc set |
| A_{c} | connection arc set |
| Aₛ | uncoupling arc set |
| Aᵣ | recoupling arc set |
| Aₒ | cross-day waiting arc set |
| δ⁺ (n) | set of outgoing arcs of node n, |
| | δ⁺ (n) = {(i, j) ∈ A \| i = n} |
| δ⁻ (n) | set of incoming arcs of node n, |
| | δ⁻ (n) = {(i, j) ∈ A \| j = n} |
| Variables: | |
| xᵢⱼ^{k} | a 0-1 variable indicating whether |
| | train k selects arc (i, j) |
| Parameters: | |
| λ | a sufficiently large positive constant |
| n_{q} | the number of coupled train units |
| | of train service q, taking a value |
| | of 1 for a single-unit train and 2 for |
| | a double-connected train group |
| uᵢⱼ | the maximum arc capacity of arc (i, j) |

### (2) Objective Function of the Original Model

The objective function of the original model is used to minimize the number of train sets used while maximizing service coverage. The objective function of the original model is expressed as:

$$min {\sum }_{( i , j ) ∈ {A}_{v}} {\sum }_{k ∈ K} {x}_{ij}^{k} - λ {\sum }_{( i , j ) ∈ {A}_{d}} {\sum }_{k ∈ K} {x}_{ij}^{k}$$

### (3) Constraints of the Original Model

### 1) Operation Diagram Constraint

For any train service q∈Q specified in the operation diagram, a number n_{q} of EMUs are required:

$${\sum }_{k ∈ K} {x}_{ij}^{k} \leq {n}_{q} , ∀ ( i , j ) ∈ {A}_{d} , ∀ q ∈ Q$$

### 2) Station Capacity Constraint

The total number of train sets waiting or operating at a station shall not exceed the maximum station capacity:

$${\sum }_{k ∈ K} {x}_{ij}^{k} \leq {u}_{ij} , ∀ ( i , j ) ∈ {A}_{c} ⋃ {A}_{s} ⋃ {A}_{r} ⋃ {A}_{o}$$

### 3) Flow Balance Constraint

Each transportation demand is served by at most one train set:

$${\sum }_{( i , j ) ∈ {δ}^{-} ( n )} {x}_{ij}^{k} - {\sum }_{( i , j ) ∈ {δ}^{+} ( n )} {x}_{ij}^{k} = {b}_{n} , ∀ k ∈ K , ∀ n ∈ N$$

$$where$$

$${b}_{n} = \{ \begin{matrix}- 1 , & ( i , j ) ∈ {A}_{v} \\ 1 , & ( i , j ) ∈ {A}_{w} \\ 0 , & otherwise\end{matrix}$$

### 4) Constraints of Decision Variables Value

$${x}_{ij}^{k} ∈ \{ 0 , 1 \} , ∀ ( i , j ) ∈ A , ∀ k ∈ K$$

(S40) An aggregative optimization model is established based on the state data and the original model, and the aggregative optimization model obtains an aggregation result based on the state data.

In an embodiment of the present disclosure, at step (S40), the aggregative optimization model is established based on the state data and the original model as follows. An aggregation optimization module of the ground data processing center establishes the aggregative optimization model based on the original model. The aggregative optimization model takes the acquired state data as input, and rapidly determines network-wide arc flow allocation through aggregation processing, to obtain the aggregation result.

In an embodiment of the present disclosure, the aggregative optimization model is established based on the state data and the original model as follows. The ground data processing center aggregates the actual position information and the accumulated mileage data in the actual position information and the accumulated mileage data in the state data of each EMU into network-wide resource allocation information. The ground data processing center aggregates, via a data aggregation algorithm, train-level variables in the original model into arc-level flow variables to reduce model complexity. The ground data processing center determines a distribution state of the EMUs in the spatiotemporal network based on the actual position information of each EMU, and determines a network-wide maintenance resource constraint based on the accumulated mileage data.

A model transformation module of the ground data processing center transforms the original model into the aggregative optimization model. An objective function of the aggregative optimization model is based on actual operating costs, and the actual operating costs include train utilization costs, operating costs, and maintenance costs. Constraint conditions of the aggregative optimization model are determined based on actual train operation diagram data and the state data, and include an operation diagram constraint, a station capacity constraint, and a flow balance constraint.

The aggregative optimization model is established as follows.

### (1) Definition of Parameters and Variables

| Parameter Name | Definition |
|---|---|
| Sets: | |
| K | candidate train set |
| Q | train service set |
| N | node set, including train service nodes |
| | and EMU depot origin/destination nodes |
| A | arc set |
| A_{d} | demand arc set |
| Aᵥ | virtual origin arc set |
| A_{w} | virtual destination arc set |
| A_{c} | connection arc set |
| Aₛ | uncoupling arc set |
| Aᵣ | recoupling arc set |
| Aₒ | cross-day waiting arc set |
| δ⁺ (n) | set of outgoing arcs of node n, |
| | δ⁺ (n) = {(i, j) ∈ A \| i = n} |
| δ⁻ (n) | set of incoming arcs of node n, |
| | δ⁻ (n) = {(i, j) ∈ A \| j = n} |
| Variables: | |
| yᵢⱼ | integer variable indicating the |
| | number of train sets using arc (i, j) |
| Parameters: | |
| λ | a sufficiently large positive constant |
| n_{q} | the number of coupled train units |
| | of train service q, taking a value |
| | of 1 for a single-unit train and 2 |
| | for a double-connected train group |
| uᵢⱼ | the maximum arc capacity of arc (i, j) |

### (2) Objective Function of the Aggregative Optimization Model

The objective function of the aggregative optimization model is used to minimize the number of train sets used while maximizing service coverage. The objective function of the aggregative optimization model is expressed as:

$$min {\sum }_{( i , j ) ∈ {A}_{v}} {y}_{ij} - λ {\sum }_{( i , j ) ∈ {A}_{d}} {y}_{ij}$$

### (3) Constraints of the Aggregative Optimization Model

### 1) Operation Diagram Constraint

For any train service q∈Q specified in the operation diagram, a number n_{q} EMUs are required:

$${\sum }_{( i , j ) ∈ {A}_{d}} {y}_{ij} \leq {n}_{q} , ∀ q ∈ Q$$

### 2) Station Capacity Constraint

The total number of train sets waiting or operating at a station shall not exceed the maximum station capacity:

$${y}_{ij} \leq {u}_{ij} , ∀ ( i , j ) ∈ {A}_{c} ⋃ {A}_{s} ⋃ {A}_{r} ⋃ {A}_{o}$$

### 3) Flow Balance Constraint

Except for the virtual origin station and the virtual destination station, the inflow equals the outflow at each node; the net outflow at the virtual origin station equals the total number of train sets, and the net inflow at the virtual destination station equals the total number of train sets:

$${\sum }_{( i , j ) ∈ {δ}^{-} ( n )} {y}_{ij} - {\sum }_{( i , j ) ∈ {δ}^{+} ( n )} {y}_{ij} = \vert K \vert {b}_{n} , ∀ k ∈ K , ∀ n ∈ N$$

$$where$$

$${b}_{n} = \{ \begin{matrix}- 1 , & ( i , j ) ∈ {A}_{v} \\ 1 , & ( i , j ) ∈ {A}_{w} \\ 0 , & otherwise\end{matrix}$$

### 4) Constraints of Decision Variables Value

$${y}_{ij} ∈ \{ 0 , 1 , … , \vert K \vert \} , ∀ ( i , j ) ∈ A$$

(S50) A disaggregation model is established based on the aggregation result, and the EMU circulation plan is automatically generated in real time by the disaggregation model by combining the aggregation result with the state data.

In an embodiment of the present disclosure, at (S50), that the disaggregation model is established based on the aggregation result and the disaggregation model combines the aggregation result with the state data to automatically generate the EMU circulation plan is performed as follows. A disaggregation solving module of the ground data processing center establishes the disaggregation model based on the aggregation result, where the disaggregation model combines the aggregation result with the acquired state data to automatically generate the EMU-identified circulation plan in real time.

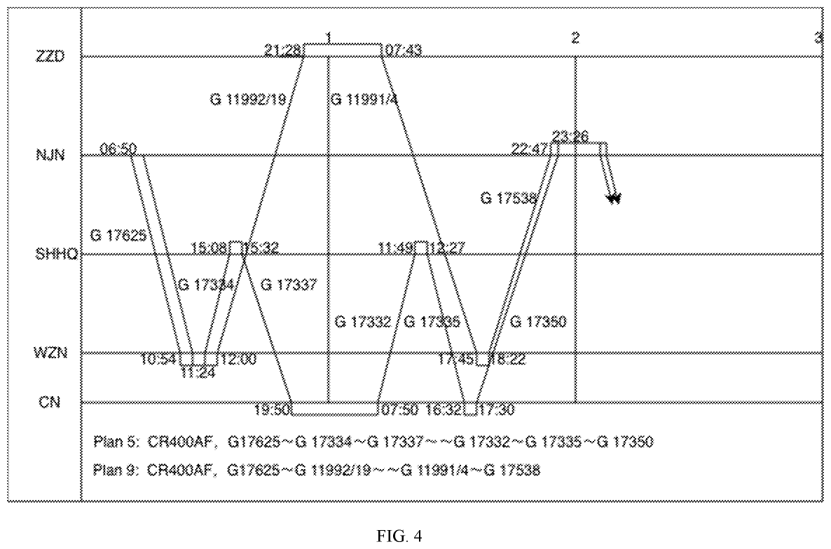

In an EMU-identified circulation plan, “identification” refers to associating abstract operational tasks with specific trains and crew members. For example, for a train service task G1→G3, identification involves assigning a specific type of train as well as the corresponding crew members to execute the task. The circulation plan may be presented in the form of a train operation diagram, as shown in FIG. 4. The diagram specifically reflects the movement trajectory of the train, including the station from which the train departs, the intermediate stations through which the train passes, the station at which the train finally arrives, and the corresponding arrival and departure time nodes at these stations.

The EMU circulation plan is ultimately presented as a specific EMU-identified circulation plan, which includes a specific EMU identification (e.g., G1→G3), specific operating time periods (e.g., 08:00-09:00, 09:10-10:00), and specific operating routes (e.g., Tianjin-Beijing, Beijing-Shanghai). The generated plan is directly transmitted to the EMU system for execution.

In an embodiment of the present disclosure, the disaggregation model combines the aggregation result with the acquired state data to automatically generate the EMU-identified circulation plan in real time as follows. The ground data processing center receives the aggregation result of the aggregative optimization model, where the aggregation result includes arc-level flow allocation information. The aggregation result is combined with the acquired state data, and the acquired state data includes GPS positioning data, the accumulated mileage data, and the maintenance state of each EMU. A data matching algorithm is used to match the aggregation result with each EMU to determine an operating section for each EMU.

The maintenance state is obtained by acquiring accumulated mileage via the onboard mileage sensor and determining whether the accumulated mileage exceeds the preset maintenance mileage threshold. If the accumulated mileage exceeds the preset maintenance mileage threshold, then maintenance is required.

An operating path is generated for each EMU based on the aggregation result and the real-time physical state via a path generation algorithm of the ground data processing center. An optimal starting position is determined based on the actual position information via a path optimization algorithm to ensure that the accumulated mileage data of each EMU does not exceed the maintenance mileage threshold. The EMU-identified circulation plan is generated in real time, where the EMU-identified circulation plan includes an EMU identifier, an operating time, and an operating path. The EMU-identified circulation plan can be directly transmitted to an EMU control system for execution.

The disaggregation model is established as follows.

### (1) Definition of Parameters and Variables

| Parameter Name | Definition |
|---|---|
| Sets: | |
| K | candidate train set |
| N | node set, including train service nodes |
| | and EMU depot origin/destination nodes |
| A | arc set |
| A_{d} | demand arc set |
| Aᵥ | virtual origin arc set |
| A_{w} | virtual destination arc set |
| δ⁺ (n) | set of outgoing arcs of node n, |
| | δ⁺ (n) = { (i, j) ∈ A \| i = n} |
| δ⁻ (n) | set of incoming arcs of node n, |
| | δ⁻ (n) = { (i, j) ∈ A \| j = n} |
| Variables: | |
| xᵢⱼ^{k} | a 0-1 variable indicating whether |
| | train k selects arc (i, j) |
| Parameters: | |
| λ | a sufficiently large positive constant |
| yᵢⱼ* | arc capacity obtained from the |
| | aggregative optimization model |

### (2) The Objective Function of the Disaggregation Model

The objective function of the disaggregation model is to minimize the number of train sets used while maximizing service coverage. The objective function of the disaggregation model is expressed as:

$$min {\sum }_{( i , j ) ∈ {A}_{v}} {\sum }_{k ∈ K} {x}_{ij}^{k} - λ {\sum }_{( i , j ) ∈ {A}_{d}} {\sum }_{k ∈ K} {x}_{ij}^{k}$$

### (3) Constraints of the Disaggregation Model

### 1) Arc Capacity Constraint

The usage of each arc shall not exceed the available capacity determined in the aggregation stage:

$${\sum }_{k ∈ K} {x}_{ij}^{k} \leq {y}_{ij}^{*} , ∀ ( i , j ) ∈ A$$

### 2) Flow Balance Constraint

It is ensured that each train departs from the virtual origin station, the inflow equals the outflow at each of all intermediate nodes, and finally converges at the virtual destination station to form a complete origin-to-destination path:

$${\sum }_{( i , j ) ∈ {δ}^{-} ( n )} {x}_{ij}^{k} - {\sum }_{( i , j ) ∈ {δ}^{+} ( n )} {x}_{ij}^{k} = {b}_{n} , ∀ k ∈ K , ∀ n ∈ N$$

$$where$$

$${b}_{n} = \{ \begin{matrix}- 1 , & ( i , j ) ∈ {A}_{v} \\ 1 , & ( i , j ) ∈ {A}_{w} \\ 0 , & otherwise\end{matrix}$$

### 3) Constraints of Decision Variables Value

$${x}_{ij}^{k} ∈ \{ 0 , 1 \} , ∀ ( i , j ) ∈ A , ∀ k ∈ K$$

The present disclosure provides a method for rapidly formulating an EMU circulation plan based on positioning data and mileage records of EMUs. The method includes: acquiring the state data of the EMUs, abstracting the stations in the train operation diagram as nodes, abstracting the feasible connection relationships between the stations as arcs, and establishing a two-day spatiotemporal network. Furthermore, the original model that takes into consideration the actual position information and the mileage constraint of each EMU is established, and a fast solution method based on a two-stage aggregation-disaggregation framework is proposed. Specifically, the aggregative optimization model is first established with an objective of minimizing the total cost over all arcs in the spatiotemporal network, so as to determine a flow on each arc, that is, the number of times each arc is used. Then, based on the aggregated solution, each routing path is solved individually to minimize the total cost of selected arcs for the routing path, thereby obtaining a detailed and EMU-identified circulation plan. Through the coordinated operation of the aggregative optimization model and the disaggregation model, the present disclosure achieves fast solution of the EMU circulation plan as follows. The aggregative optimization model first determines a flow distribution for each arc, and then the disaggregation model, based on the aggregation result and the state data of the EMUs, generates the EMU-identified circulation plan for each EMU in real time. The EMU-identified circulation plan includes an EMU identifier, an operating time, and an operating path, and can be directly transmitted to the EMU control system for execution, thereby enabling EMU-identified circulation plan optimization based on the state data of the EMUs. As a result, the problem in conventional methods that EMU circulation plans do not match the actual position information of each EMU due to inability to obtain the state data of the EMUs is overcome, solution speed is significantly improved, and practical applicability and operability of the EMU circulation plan are ensured.

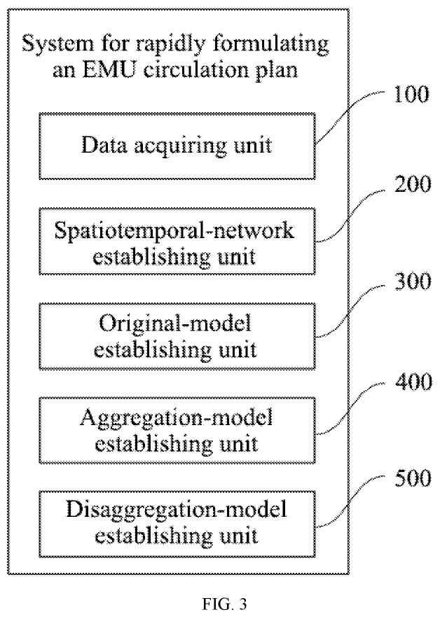

As shown in FIG. 3, an embodiment of the present disclosure further provides an optimization system for rapidly formulating an EMU circulation plan. The optimization system includes a data acquiring unit 100, a spatiotemporal-network establishing unit 200, an original-model establishing unit 300, an aggregation-model establishing unit 400, and a disaggregation-model establishing unit 500. The data acquiring unit is configured to acquire state data of the EMUs. The spatiotemporal-network establishing unit is configured to establish a spatiotemporal network of the EMUs based on the state data of the EMUs. The original-model establishing unit is configured to establish an original model of the EMUs based on the state data of the EMUs and the spatiotemporal network of the EMUs. The state data at least comprise, for each of the EMUs, actual position information, accumulated mileage data, and maintenance state data. The aggregation-model establishing unit is configured to establish an aggregative optimization model based on the state data and the original model. The aggregative optimization model is solved based on the state data to obtain an aggregation result. The disaggregation-model establishing unit is configured to establish a disaggregation model based on the aggregation result. The disaggregation model is configured to combine the aggregation result with the state data to automatically generate the EMU circulation plan in real time.

The present disclosure further provides a computer system including one or more processors, a memory, and one or more programs stored in the memory and configured to be executed by the one or more processors, where the one or more programs include instructions for executing the above-mentioned method.

The processor may be a general-purpose processor, a special-purpose processor, a digital signal processor (DSP), a microprocessor, a controller, a microcontroller, or another programmable processing device, or any combination thereof.

The memory may include, but is not limited to, random access memory (RAM), read-only memory (ROM), flash memory, magnetic storage devices, optical storage devices, solid-state drives, or any other storage medium capable of storing computer-executable instructions.

The processor is configured to execute the instructions stored in the memory, thereby implementing the method steps described herein, including processing of the state data, establishment of the spatiotemporal network, aggregation-based optimization computation, and disaggregation solving operations.

The present disclosure further provides a non-transitory computer-readable storage medium storing one or more programs which, when executed by one or more processors, cause the one or more processors to perform the above-mentioned method.

The non-transitory computer-readable storage medium is not limited to any specific type, and may be any tangible storage medium capable of storing instructions and usable by an instruction execution system, apparatus, or device.

It should be understood that the computer system and the non-transitory computer-readable storage medium described above are provided for illustrative purposes only, and do not limit the scope of the present disclosure. Any equivalent computer system architecture or storage medium capable of implementing the method described herein shall fall within the scope of the present disclosure.

The method and system of the present disclosure are specifically implemented by a computer system, and the computer system is in communication with the onboard sensor assembly deployed on the EMUs.

The state data processed by the computer system are not abstract data, but are directly derived from physical measurement results, including positioning signals received by the GPS positioning sensors and mileage signals detected by the mileage sensors. These physical measurement results impose non-negligible practical constraints on the feasibility of the EMU circulation plan.

During establishment of the spatiotemporal network, establishment of optimization models, and execution of disaggregation solving, the computer system continuously integrates the physical state data collected by the above-mentioned sensors, thereby ensuring that the generated EMU circulation plan remains consistent with the actual railway operating state.

The present disclosure addresses a technical problem in a computer-implemented railway operating system, specifically: how to generate, in real time and with acceptable computational complexity, an executable EMU circulation plan under large-scale constraints driven by sensor-based state data.

By introducing a two-stage computational architecture combining the aggregative optimization model and the disaggregation model, the present disclosure significantly reduces the dimensionality of decision variables that must be processed by the computer system, effectively reduces computational burden, and improves solution speed and stability in a real-time operating environment, thereby overcoming the technical bottleneck of insufficient computational efficiency of conventional models in large-scale scenarios.

The EMU circulation plan generated by the present disclosure is directly constrained by real-time physical states of the EMUs, including real-time position information collected by onboard sensors and accumulated mileage data, and the generated EMU circulation plan can be directly executed by an EMU control system, thereby forming a closed-loop technical solution tightly coupled with actual railway operations.

Compared with conventional methods for formulating EMU circulation plans, the present disclosure achieves at least the following technical effects: (1) reduced computational complexity: by aggregating train-level decision variables into arc-level flow variables, the number of decision variables and constraint scales that must be processed by the computer system is significantly reduced; (2) improved real-time performance: the aggregative optimization model enables the computer system to generate feasible circulation plans within time limits required for real-time railway dispatching; (3) enhanced system stability: the two-stage optimization architecture improves solver convergence in large-scale scenarios and reduces the risk of computational instability; and (4) direct physical executability: the generated EMU circulation plan is directly constrained by EMU physical states and can be directly executed by the EMU control system without manual post-processing.

Accordingly, the present disclosure provides a substantive technical improvement to computer-implemented EMU circulation plan systems.

It should also be understood that although the steps are described in a certain order, the steps are not necessarily performed in the order described above. Unless explicitly stated herein, the execution of the steps is not strictly limited in sequence, and the steps may be performed in other orders. Moreover, some steps of the embodiments may include multiple sub-steps or stages, and such sub-steps or stages are not necessarily completed simultaneously but may be performed at different times. The execution order of these sub-steps or stages is also not necessarily sequential, and may be alternately performed with at least a portion of other steps or their sub-steps or stages.

It should be understood that, unless the context clearly indicates otherwise, the singular form “a” or “an” as used herein is also intended to include the plural form. It should further be understood that the term “and/or” as used herein refers to any and all possible combinations of one or more of the associated listed items. The embodiment numbers disclosed in the present disclosure are used merely for descriptive purposes and do not imply superiority or inferiority of the embodiments.

Those of ordinary skill in the art should understand that the above embodiments are exemplary only, and are not intended to limit the present disclosure. Within the concepts of the present disclosure, the above embodiments or technical features therein may be combined as long as there is no contradiction. Accordingly, it should be noted that any modifications, equivalent substitutions and improvements made within the spirit and principles of the present disclosure shall fall within the scope of the present disclosure defined by the appended claims.

What is claimed is:

1. A computer-implemented method for automatically formulating an electric multiple unit (EMU) circulation plan, comprising:
deploying an onboard sensor assembly on EMUs;
acquiring, by the onboard sensor assembly, state data of the EMUs in real time;
establishing a spatiotemporal network based on the state data;
establishing an original model of the EMU circulation plan based on the state data and the spatiotemporal network, wherein the state data comprise operation state data and maintenance state data;
establishing an aggregative optimization model based on the state data and the original model;
solving the aggregative optimization model based on the state data to obtain an aggregation result;
establishing a disaggregation model based on the aggregation result; and
combining, by the disaggregation model, the aggregation result with the state data to automatically generate the EMU circulation plan in real time.

2. The computer-implemented method according to claim 1, wherein the operation state data comprises actual position information and accumulated mileage data;
the actual position information comprises a current station, an operating section, or an EMU depot; and
the accumulated mileage data comprises a total accumulated mileage, a daily accumulated mileage, and a maintenance cycle accumulated mileage.

3. The computer-implemented method according to claim 2, wherein the step of establishing the spatiotemporal network based on the state data comprises:
based on the actual position information, establishing an initial node in the spatiotemporal network for each of the EMUs, and assigning a temporal attribute, a spatial attribute, and a state attribute to the initial node;
searching a database to determine the EMU depot, the current station, or the operating section of each of the EMUs, and establishing a virtual origin node and a virtual destination node for each of the EMUs;
comparing, via a maintenance state determination algorithm, the accumulated mileage data with a maintenance mileage threshold to determine a maintenance state of each of the EMUs;
for an EMU among the EMUs whose accumulated mileage data reaches the maintenance mileage threshold, restricting executable long-distance operating tasks of the EMU, and adjusting an arc capacity of the EMU;
for an EMU among the EMUs whose accumulated mileage data exceeds the maintenance mileage threshold, removing the EMU from an available EMU set such that no node in the spatiotemporal network is established for the EMU;
setting an operating section and a time window for each of the EMUs according to a preset maintenance plan; and
based on the state data, abstracting, via a network generation algorithm, stations in a train operation diagram as nodes, and feasible connection relationships between the stations as arcs, so as to establish the spatiotemporal network for a preset period based on the state data.

4. The computer-implemented method according to claim 1, wherein the step of establishing the original model based on the state data and the spatiotemporal network comprises:
taking a candidate train set, a node set and an arc set as model parameters;
based on the actual position information, setting an initial position constraint for each of the EMUs to ensure that each of the EMUs starts executing the EMU circulation plan from its actual position;
based on the accumulated mileage data, setting a maintenance constraint to ensure that the maintenance cycle accumulated mileage of each of the EMUs does not exceed a maintenance mileage threshold prior to maintenance; and
based on actual train operation diagram data, setting an operation diagram constraint, a station capacity constraint, and a flow balance constraint.

5. The computer-implemented method according to claim 1, wherein the step of establishing the aggregative optimization model based on the state data and the original model comprises:
aggregating the actual position information and the accumulated mileage data in the state data of each of the EMUs into network-wide resource allocation information;
aggregating, via a data aggregation algorithm, train-level variables in the original model into arc-level flow variables to reduce model complexity;
determining a distribution state of the EMUs in the spatiotemporal network based on the actual position information of each of the EMUs, and determining a network-wide maintenance resource constraint based on the accumulated mileage data of each of the EMUs; and
transforming the original model into the aggregative optimization model.

6. The computer-implemented method according to claim 5, wherein an objective function of the aggregative optimization model is determined based on actual operating costs, wherein the actual operating costs comprise train utilization costs, operating costs, and maintenance costs.

7. The computer-implemented method according to claim 6, wherein constraint conditions of the aggregative optimization model are determined based on actual train operation diagram data and the state data; and
the constraint conditions of the aggregative optimization model comprise an operation diagram constraint, a station capacity constraint, and a flow balance constraint.

8. The computer-implemented method according to claim 1, wherein the step of combining, by the disaggregation model, the aggregation result with the state data to automatically generate the EMU circulation plan in real time comprises:
based on the aggregation result and the state data, matching, via a data matching algorithm, the aggregation result with each of the EMUs to determine an operating section for each of the EMUs;
based on the aggregation result and the state data, generating an operating path for each of the EMUs;
determining, via a path optimization algorithm, an optimal starting position based on the actual position information, and ensuring that the accumulated mileage data of each of the EMUs does not exceed a maintenance mileage threshold; and
generating the EMU circulation plan in real time, wherein the EMU circulation plan comprises an EMU identifier, an operating time, and an operating path.

9. A computer system, comprising:
one or more processors;
a memory; and
one or more programs stored in the memory and configured to be executed by the one or more processors to cause the one or more processors to execute the computer-implemented method according to claim 1.

10. A non-transitory computer-readable storage medium storing one or more programs which, when executed by one or more processors, cause the one or more processors to perform the computer-implemented method according to claim 1.
